(19) United States
(12) Patent Application Publication
(10) Pub. No.: US 2024/0338692 A1
(43) Pub. Date: Oct. 10, 2024

(54) METHOD AND SYSTEM OF A BLOCKCHAIN PAYMENT SOLUTION FOR PAYMENT CARDS WITH SELF-CUSTODIAL WALLETS

(71) Applicant: Mastercard International Incorporated, Purchase, NY (US)

(72) Inventors: Lakshay JHAMB, Plano, TX (US); Ao LI, Jersey City, NJ (US); Lola ROBERTS, New York, NY (US); Noah EGGENSCHWILER, Tinton Falls, NJ (US)

(21) Appl. No.: 18/131,468

(22) Filed: Apr. 6, 2023

(51) Int. Cl. G06Q 20/38; G06Q 20/34; G06Q 20/36; G06Q 20/40

(52) U.S. Cl. CPC G06Q 20/389; G06Q 20/34; G06Q 20/3678; G06Q 20/4014

(57) ABSTRACT

A method for processing a blockchain transaction using a payment card and a linked blockchain wallet includes: receiving an authorization request for a payment transaction initiated using the payment card, wherein the authorization request includes transaction data, the transaction data including at least a payment card number, a transaction amount, and a destination address; identifying the linked blockchain wallet based on an association between the linked blockchain wallet and the payment card number; verifying compliance with one or more restrictions on use of the linked blockchain wallet based on at least the transaction data and a transaction history of the linked blockchain wallet; and executing a smart contract stored on a blockchain of a blockchain network associated with the linked blockchain wallet, where at least the transaction amount and destination address are provided as input for the smart contract.

### FIELD

The present disclosure relates to the processing of payment transactions for self-custodial wallets, specifically the use of a linked payment card to make payments from a self-custodial blockchain wallet through presenting the payment card to a merchant.

### BACKGROUND

Blockchain transactions were started as an alternative to the use of fiat currency for the technologically savvy, where a distributed and decentralized network was used to track the transactions. Blockchain currency, also referred to as cryptocurrency, started at a relatively small value and has since exploded in worth due to more widespread use and significant investment and trading. Traditionally, users controlled their own blockchain wallets, referred to as a “self-custodial” wallet, where they remained in possession of the private key used to sign their blockchain transactions. However, some users found it difficult to keep track of their private key and preferred a more familiar system, where their currency was held for them by a third party, known as an exchange, that would control their private key for the user and provide them the opportunity to exchange their blockchain currency for fiat currency.

However, in recent years there have been countless stories of blockchain exchanges that have shutdown or engaged in fraudulent activity, leaving the users who surrendered their private keys to the exchange without control over their own blockchain currency, with very significant loss of value. Because of the decentralized nature of blockchains, the currency is lost and cannot be recovered by the user. As a result of these stories, many users have opted to use a self-custodial wallet to ensure the safety and security of their blockchain currency. Still, the increase in complexity of blockchain transactions over the years has made the operation of a self-custodial wallet even more difficult and daunting for the average user. At the same time, consumers are very familiar and comfortable with the use of payment cards for payment transactions. However, there are a lack of systems for enabling a consumer to utilize blockchain currency in a transaction conducted with a payment card.

Thus, there is a need for a technological solution for the facilitation of blockchain payments for self-custodial wallets using linked payment cards. SUMMARY

The present disclosure provides a description of systems and methods for processing blockchain transactions using a payment card and a linked blockchain wallet. A consumer links their blockchain wallet with their payment card with a processing platform, which has a smart contract stored on the blockchain that authorizes the processing platform to conduct blockchain transactions on behalf of the consumer. The consumer can use their payment card at a merchant for a transaction that is to be funded with blockchain currency. An authorization request for the transaction gets routed through traditional payment rails to the processing platform, which identifies the blockchain wallet linked to the payment card that was used. The processing platform then, via the smart contract, submits a new blockchain transaction on the blockchain for the appropriate amount from the consumer's blockchain wallet to the merchant. The result is a system where a consumer can conduct a blockchain transaction for the use of blockchain currency at a merchant through the use of their traditional payment card, which can provide significant convenience and ease-of-use to consumers while enabling merchants to accept blockchain currency using traditional points of sale with minimal modification.

A method for processing a blockchain transaction using a payment card and a linked blockchain wallet includes: receiving, by a receiver of a processing server, an authorization request for a payment transaction initiated using the payment card, wherein the authorization request includes transaction data, the transaction data including at least a payment card number, a transaction amount, and a destination address; identifying, by a processor of the processing server, the linked blockchain wallet based on an association between the linked blockchain wallet and the payment card number; verifying, by the processor of the processing server, compliance with one or more restrictions on use of the linked blockchain wallet based on at least the transaction data and a transaction history of the linked blockchain wallet; and executing, by a transmitter of the processing server, a smart contract stored on a blockchain of a blockchain network associated with the linked blockchain wallet, where at least the transaction amount and destination address are provided as input for the smart contract.

A system for processing a blockchain transaction using a payment card and a linked blockchain wallet includes: a blockchain network; and a processing server, the processing server including a receiver receiving an authorization request for a payment transaction initiated using the payment card, wherein the authorization request includes transaction data, the transaction data including at least a payment card number, a transaction amount, and a destination address, a processor identifying the linked blockchain wallet based on an association between the linked blockchain wallet and the payment card number, and verifying compliance with one or more restrictions on use of the linked blockchain wallet based on at least the transaction data and a transaction history of the linked blockchain wallet, and a transmitter executing a smart contract stored on a blockchain of the blockchain network associated with the linked blockchain wallet, where at least the transaction amount and destination address are provided as input for the smart contract.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing blockchain transactions using a payment card linked to a blockchain wallet in accordance with exemplary embodiments.

FIG. 2 is a block diagram illustrating the processing server in the system of FIG. 1 for processing blockchain transactions using a payment card linked to a blockchain wallet in accordance with exemplary embodiments.

FIG. 3 is a flow diagram illustrating a process for the registration and linking of a payment card to a blockchain wallet in the system of FIG. 1 in accordance with exemplary embodiments.

FIGS. 4A and 4B are a flow diagram illustrating a process for processing blockchain transactions using a payment card linked to a blockchain wallet in accordance with exemplary embodiments.

FIG. 5 is a flow chart illustrating an exemplary method for processing blockchain transactions using a payment card linked to a blockchain wallet in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Processing Blockchain Transactions with Linked Payment Cards

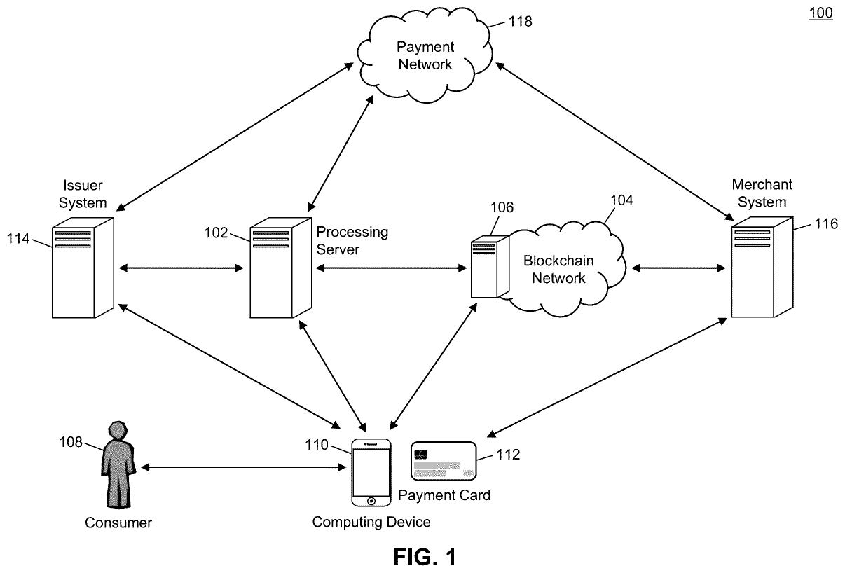

FIG. 1 illustrates a system 100 for the processing of a blockchain transaction initiated via a payment card that is linked to a self-custodial blockchain wallet.

The system 100 can include a processing server 102. The processing server 102, discussed in more detail below, can be configured to link self-custodial blockchain wallets to payment cards, to enable blockchain transactions through the use of the linked payment card.

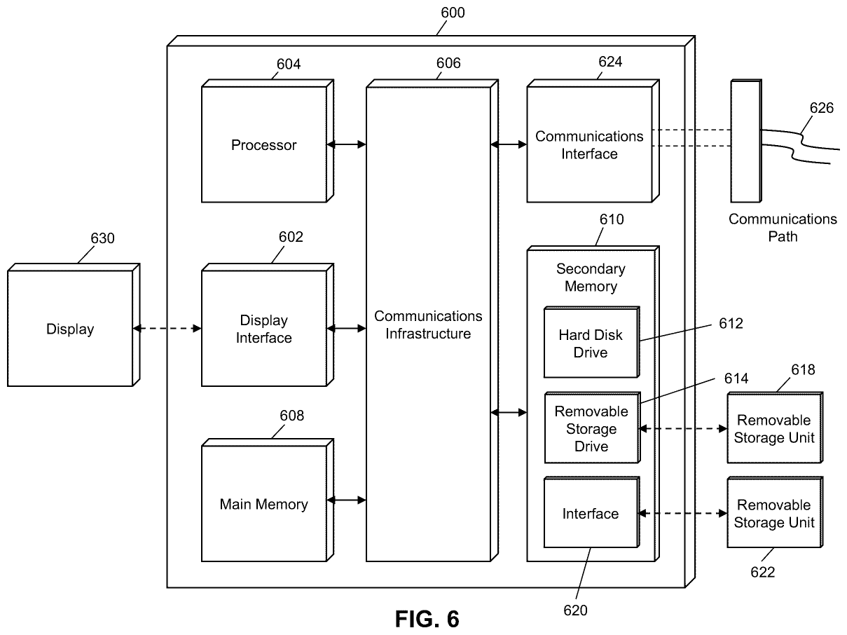

The system 100 can also include a blockchain network 104. The blockchain network 104 can be comprised of a plurality of blockchain nodes 106. Each blockchain node 106 can be a computing system, such as illustrated in FIG. 6, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in the blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” can refer specifically to the private key. In other cases, the term “blockchain wallet” can refer to a computing device (e.g., computing device 110, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a computing device 110) that is generated using the sender's private key, a blockchain address of the recipient of currency (e.g., a merchant system 116) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in the blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

The system 100 can also include a payment network 118. A payment network 118 can be a system or network used for the transfer of money via the use of cash-substitutes for thousands, millions, and even billions of transactions during a given period. Payment networks can use a variety of different protocols and procedures in order to process the transfer of money for various types of transactions. Transactions that can be performed via a payment network can include product or service purchases, credit purchases, debit transactions, fund transfers, account withdrawals, etc. Payment networks can be configured to perform transactions via cash-substitutes, which can include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein can refer to both the payment network as an entity, and the physical payment network, such as the equipment, hardware, and software comprising the payment network, which are also known as “payment rails.”

As used herein, “transaction account” can refer to a financial account that can be used to fund a transaction, such as a checking account, savings account, credit account, virtual payment account, etc. A transaction account can be associated with a consumer 108, which can be any suitable type of entity associated with a payment account, which may include a person, family, company, corporation, governmental entity, etc. In some instances, a transaction account can be virtual, such as those accounts operated by PayPal®, etc. Traditionally, a transaction account can be accessed and used via a payment card 112. As used herein, “payment card” can refer to a card, which can be a physical card or a virtual card, which can be presented to a merchant for use of the associated transaction account in funding a payment transaction. In some cases, the term payment card can refer to a digital token provisioned to a computing device 110 that is used for payment transactions. In an exemplary embodiment, a payment card 112 can be provisioned to a consumer 108 via by an issuer system 114.

The issuer system 114 can be associated with an issuer, which can be an entity that establishes (e.g., opens) a letter or line of credit in favor of a beneficiary, and honors drafts drawn by the beneficiary against the amount specified in the letter or line of credit. In many instances, the issuer can be a bank or other financial institution authorized to open lines of credit. In some instances, any entity that can extend a line of credit to a beneficiary may be considered an issuer. The line of credit opened by the issuer can be represented in the form of a payment account, and may be drawn on by the beneficiary via the use of the payment card 112. An issuer can also offer additional types of payment accounts to consumers 108 as will be apparent to persons having skill in the relevant art, such as debit accounts, prepaid accounts, electronic wallet accounts, savings accounts, checking accounts, etc., and may provide consumers 108 with physical or non-physical means for accessing and/or utilizing such an account, such as debit cards, prepaid cards, automated teller machine cards, electronic wallets, checks, etc.

Traditionally, the consumer 108 can use their issued payment card 112 to fund a payment transaction with a merchant system 116 (e.g., via a point of sale or other interface of the merchant system 116) with a fiat currency via the associated transaction account. As used herein, “payment transaction” can refer to a transaction between two entities in which money or other financial benefit is exchanged from one entity to the other. The payment transaction can be a transfer of funds, for the purchase of goods or services, for the repayment of debt, or for any other exchange of financial benefit as will be apparent to persons having skill in the relevant art. In some instances, payment transaction can refer to transactions funded via a payment card 112 and/or payment account, such as credit card transactions. Such payment transactions can be processed via an issuer system 114, payment network 118, and acquirer. The process for processing such a payment transaction can include at least one of authorization, batching, clearing, settlement, and funding. Authorization can include the furnishing of payment details by the consumer 108 to the merchant system 116, the submitting of transaction details (e.g., including the payment details) from the merchant system 116 to their acquirer, and the verification of payment details with the issuer system 114 of the consumer's payment account used to fund the transaction. Batching can refer to the storing of an authorized transaction in a batch with other authorized transactions for distribution to an acquirer. Clearing can include the sending of batched transactions from the acquirer to a payment network 118 for processing. Settlement can include the debiting of the issuer by the payment network 118 for transactions involving beneficiaries of the issuer. In some instances, the issuer can pay the acquirer via the payment network 118. In other instances, the issuer can pay the acquirer directly. Funding can include payment to the merchant from the acquirer for the payment transactions that have been cleared and settled. It will be apparent to persons having skill in the relevant art that the order and/or categorization of the steps discussed above performed as part of payment transaction processing.

In the system 100, the consumer 108 can be interested in using their payment card 112 to initiate a purchase with a merchant system 116 that is funded via their self-custodial blockchain wallet on their computing device 110 instead of the transaction account traditionally linked to the payment card. Such a service can be offered by the processing server 102. The processing server 102 can be a part of the issuer system 114, can be a blockchain node 106 in the blockchain network 104, a part of the payment network 118, or a separate entity and/or system.

To provide the service, the consumer 108 can first register with the processing server 102. To register, the consumer 108 can, using their computing device 110, provide the processing server 102 with payment details of their payment card 112, as well as at least an identifier associated with their blockchain wallet, such as the public key thereof. The payment details can include any information suitable for use in identifying the payment card 112 when used in a payment transaction, such as the transaction account number, name on the transaction account, security code, expiration date, etc. In some cases, the processing server 102 can receive the payment details and verify that the consumer 108 has authority to link the payment card 112. To perform the verification, the processing server 102 can contract the issuer system 114 using a suitable communication network and method to ensure that the consumer 108 has authority to use the payment card 112. In such cases, the submission by the consumer 108 to register with the processing server 102 can include identifying data for the consumer 108, which the processing server 102 can provide to the issuer system 114 with the payment details as part of the verification.

Once verification is complete, the processing server 102 can store an association between the blockchain wallet of the computing device 110 and the payment card 112 in an account profile associated with the consumer 108 and/or computing device. In some cases, the consumer 108 can provide one or more limits on use of the payment card 112 for their blockchain transactions. Limits can include limits on transaction amount, frequency, merchants, date and/or time, etc., and can be placed overall on the use of the payment card 112, for single transactions, for all transactions, for specific periods of time, etc. In these cases, the processing server 102 can store such criteria in the account profile.

As part of the registration process, the processing server 102 can receive permission from the consumer 108 (e.g., in the initial registration request for via a separate communication between the computing device 110 and processing server 102) for the processing server 102 to conduct a blockchain transaction with the blockchain wallet of the computing device 110 on behalf of the consumer 108. As part of the permission, the consumer 108 can provide the necessary data required by the blockchain network 104 to authorize a separate entity to conduct payment transactions using their blockchain wallet. Such data can include, for example, unspent transaction outputs, blockchain addresses, cryptographic keys, digital signatures, etc.

Following receipt of the permission and linking of the blockchain wallet and payment card 112, the processing server 102 can generate a smart contract that is submitted to a blockchain node 106 in the blockchain network 104 for confirmation and storage in the blockchain associated therewith. The smart contract can include the relevant data to ensure that the processing server 102 can initiate a blockchain transaction using the computing device's blockchain wallet, such as the blockchain wallet's public key, a digital signature generated by the computing device's private key, a public key of the processing server's cryptographic key pair, etc.

Once the smart contract has been added to the blockchain, the processing server 102 can transmit a confirmation message to the consumer 108 via the computing device 110 indicating that the consumer 108 is free to use the payment card 112 for payment via their blockchain wallet. The consumer 108 can receive the confirmation and then conduct a transaction with a merchant system 116. As part of the transaction, the consumer 108 can (e.g., themselves in a payment transaction conducted at a brick-and-mortar location or via their computing device 110) select to make payment to the merchant via blockchain currency. For payment, the consumer 108 can present the payment card 112. The merchant system 116 can receive the payment details from the payment card 112 using a suitable method (e.g., magnetic stripe, integrated circuit, near field communication, etc.) and include the payment details, selected currency, transaction amount, destination address, and other suitable transaction data in a transaction message. The transaction message can be generated by the merchant system 116 and transmitted to the payment network 118 for processing via payment rails associated therewith. In some embodiments, the transaction message can be formatted according to one or more standards governing the interchange of financial transaction messages, such as the International Organization of Standardization's ISO 8583 or ISO 20022 standards. In such an embodiment, the transaction message submitted by the merchant system 116 can be an authorization request as indicated in a message type indicator, and can include a plurality of data elements used to store the transaction data. Additional transaction data included in the transaction message can include, for example, transaction time and/or date, point of sale identifier, merchant identification number, acquirer data, product data, etc.

The payment network 118 can receive the authorization request and can route the transaction message based on the data included therein. The routing can be based on the payment card number included in the payment details, which can include a bank identification number. The payment network 118 can identify the bank identification number and route the transaction message to an entity and/or system associated therewith. In some cases, the authorization request can be transmitted directly to the processing server 102 as a result of the routing. In other cases, the authorization request can be transmitted to the issuer system 114 via the routing, which can then forward the authorization request to the processing server 102 as a result of the registration of the payment card 112 by the consumer 108.

Once the processing server 102 receives the authorization request, the processing server 102 can identify the account profile using the payment details and identify the blockchain wallet linked thereto. The processing server 102 can verify that the payment transaction is in compliance with any criteria set forth by the consumer 108. For example, the processing server 102 can ensure that the transaction amount of blockchain currency for the new transaction is within a limit set by the consumer 108. Such a limit can be a set value (e.g., the transaction must be below 100 units of currency) or can be a percentage (e.g., the transaction must be below 80% of the remaining account balance for the blockchain wallet). If the payment transaction is not in compliance with all of the criteria, the processing server 102 can decline the transaction. The processing server 102 can generate an authorization response that includes a response code indicating a decline and forward the authorization response to the payment network 118 (e.g., directly via payment rails associated therewith or via the issuer system 114). The transaction can then be completed without payment using traditional methods.

If the payment transaction does comply with all applicable criteria, the processing server 102 can use the transaction data as input into the smart contract stored on the blockchain. The processing server 102 can electronically transmit the appropriate transaction data to a blockchain node 106, which can execute the smart contract using the provided data. The transaction data can include at least the transaction amount, the destination address (e.g., corresponding to a blockchain wallet of the merchant system 116 used to receive the blockchain currency), and any data necessary for the processing server 102 to provide as part of its authorization to conduct transactions on behalf of the computing device 110. For example, the processing server 102 can digitally sign the message submitted to the blockchain node 106 for the smart contract using its private key, where the blockchain node 106 can validate the signature using the processing server's public key, which can be retrieved from the smart contract. The smart contract can be executed with the supplied data to add a new blockchain transaction to the blockchain for payment of the specified amount of blockchain currency from the blockchain wallet of the computing device 110 to a blockchain wallet of the merchant system 116. As a result, the consumer 108 can make a payment with blockchain currency using their payment card 112.

Once the new blockchain transaction has been added, the blockchain node 106 can return a confirmation message to the processing server 102. In some cases, the confirmation message can include a transaction identifier that identifies the blockchain transaction added to the blockchain. The processing server 102 can generate an authorization response message that includes a response code indicating approval of the payment transaction, which can be transmitted to the payment network 118 and returned to the merchant system 116 via the payment rails. The merchant can then finalize the transaction with the consumer 108, such as by providing the transacted-for goods or services to the consumer 108. In cases where a transaction identifier is provided to the processing server 102, the processing server 102 can include the transaction identifier in the authorization response, or in a separate confirmation message transmitted to the computing device 110.

In some embodiments, when the payment card 112 is linked to a blockchain wallet, the payment card 112 can only be used for payments made via the linked blockchain wallet in the appropriate blockchain currency. In such an embodiment, transaction messages that include a currency code for a different currency can be declined by the processing server 102. In other embodiments, the payment card 112 can be used for both blockchain currency and fiat currency, where the payment transaction can be processed based on the currency indicated in the transaction message. In such an embodiment, the issuer system 114 can process the payment transaction for fiat currency transactions, but can forward the transaction message to the processing server 102 if a blockchain currency is selected. In some cases, a payment card 112 can be linked to multiple blockchain wallets, which can include multiple blockchain wallets for a single blockchain, or one or more blockchain wallets for multiple blockchains, which can utilize different blockchain currencies.

In some embodiments, the payment card 112 can be used for payments made via the linked blockchain wallet, where the blockchain currency can be paid to an entity other than the merchant system 116. In such embodiments, the merchant system 116 can request payment via fiat currency or a currency other than the blockchain currency utilized by the linked blockchain wallet. The processing server 102 can verify compliance with the consumer's criteria, and then initiate the blockchain transaction for payment to the appropriate party. The appropriate party can include the issuer system 114, which can pay fiat currency to the merchant system 116 or the merchant's acquirer and receive the equivalent blockchain currency from the linked blockchain wallet, the acquirer for the merchant system 116, which can pay fiat currency to the merchant system 116, or a third party that can pay fiat currency to the merchant system 116. In some cases, the transaction message can indicate the party to be provided the blockchain currency (e.g., via an included destination address). In some instances, the account profile for the consumer 108 can indicate where the blockchain currency is to be paid (e.g., to their issuer system 114, which is configured to make fiat payments upon receipt of blockchain currency from the consumer 108 when the payment card 112 is used).

In some cases, the blockchain currency used by the consumer 108 via the blockchain wallet on their computing device 110 can be different from the blockchain currency used by the merchant system 116. In such cases, a swap can be utilized to convert the consumer's blockchain currency to the merchant's blockchain currency. In some cases, the processing server 102 can perform the swap as part of the processing discussed above. In other cases, a third party system can be utilized to perform the swap, which can be a blockchain node 106 in a blockchain network 104 for one of the blockchain currencies or other suitable system. When a swap is utilized, the consumer 108 can use their payment card 112 that is linked to their blockchain wallet as discussed above. When the new blockchain transaction is to be created, a swap can be performed by a suitable entity to convert the consumer's blockchain currency to the merchant's blockchain currency. A first blockchain transaction on the blockchain network 104 for the consumer's blockchain currency can be created to transfer the specified amount of the consumer's blockchain currency to a third party wallet, which can be controlled by or otherwise associated with the system performing the swap. A second blockchain transaction can be created on the blockchain network 104 for the merchant's blockchain currency for a suitable amount (e.g., converted to/from the amount of the first blockchain currency) from a third party wallet, which can be controlled by or otherwise associated with the system performing the swap, to the wallet of the merchant system 116. In such an example, the consumer 108 can perform the same processes discussed above and still use their payment card 112 to make a payment with a linked blockchain wallet even in cases where the merchant system 116 utilizes a different blockchain currency.

In exemplary embodiments, the communications discussed herein between components in the system 100 can be cryptographically secure. Suitable cryptographic methods can be used to ensure that communications transmitted from one component in the system 100 (e.g., the computing device 110) to another component in the system 100 (e.g., the processing server 102) is cryptographically secure and cannot be read by an unauthorized entity or system. Such cryptographic methods can include hashing, encryption, the use of shared secrets, or other methods that will be apparent to persons having skill in the art. In an example, the registration data transmitted from the computing device 110 to the processing server 102 can be encrypted using a public key provided by the processing server 102 to the computing device 110, which can only be decrypted using a corresponding private key possessed by the processing server 102. In another example, the processing server 102 and computing device 110 can exchange cryptographic keys and each generate a shared secret used to encrypt and decrypt messages exchanged between the two systems.

The methods and systems discussed herein enable a consumer 108 to use their payment card 112 to make a payment of blockchain currency via a linked blockchain wallet. The linkage between payment card 112 and blockchain wallet, maintained by the processing server 102, can provide for significantly greater usage of blockchain transactions by the consumer 108 for a self-custodial wallet without requiring the consumer 108 to navigate the technological difficulties of using a blockchain wallet directly. In addition, merchant systems 116 can receive payment via blockchain currency more easily by utilizing existing infrastructure and messaging systems with minimal modification, providing greater opportunity for merchants. Accordingly, the methods and systems discussed herein provide significant technological improvements over existing systems.

### Processing Server

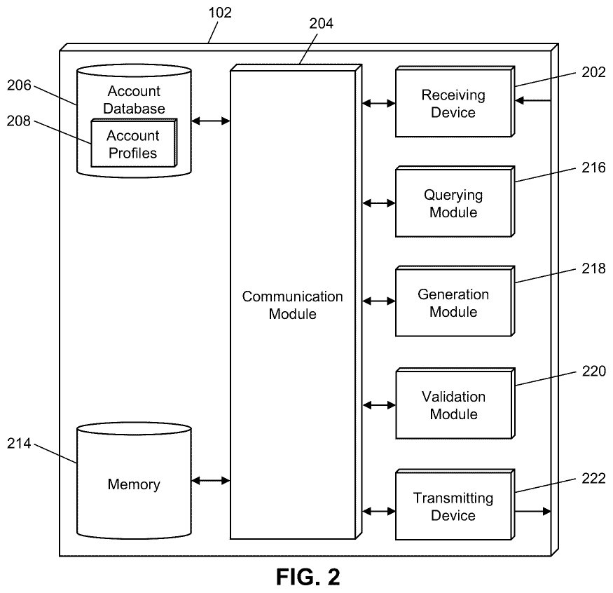

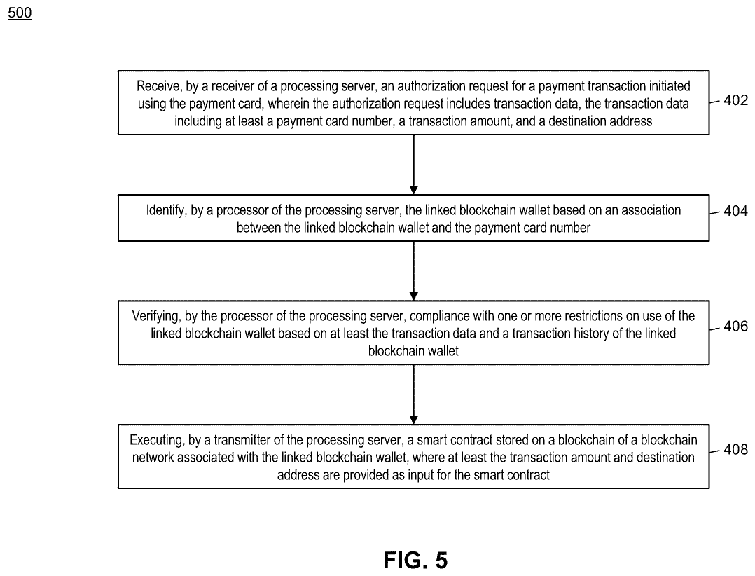

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, additional components of the system 100, such as the blockchain nodes 106, issuer system 14, merchant system 116, and computing device 110, can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from blockchain nodes 106, computing devices 110, issuer systems 114, merchant systems 116, payment networks 118, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that can be superimposed or otherwise encoded with blockchain data, transaction identifiers, smart contract data, verification results, cryptographic keys, etc. The receiving device 202 can also be configured to receive data signals electronically transmitted by computing devices 110, which can be superimposed or otherwise encoded with registration data, payment details, cryptographic keys, digital signatures, account balances, transaction criteria, etc. The receiving device 202 can also be configured to receive data signals electronically transmitted by issuer systems 114, merchant systems 116, and payment networks 118 that can be superimposed or otherwise encoded with transaction messages, authentication data, destination addresses, cryptographic keys, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a computing device 110 and/or a consumer 108. An account profile 208 can store a linkage between a blockchain wallet, which can utilize a public key or other identifier for the blockchain wallet, and a payment card 112, which can utilize a payment account number or other identifier thereof. An account profile 208 can also include criteria required of blockchain transactions conducted using the linked payment card 112, rules regarding use of the payment card 112 for non-linked transactions, and other data as discussed herein.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, payment details, blockchain wallet data, transaction messaging data, etc.

The processing server 102 can include a querying module 216. The querying module 216 can be configured to execute queries on databases to identify information. The querying module 216 can receive one or more data values or query strings, and can execute a query string based thereon on an indicated database, such as the entity database 206 of the processing server 102 to identify information stored therein. The querying module 216 can then output the identified information to an appropriate engine or module of the processing server 102 as necessary. The querying module 216 can, for example, execute a query on the account database 206 to identify an account profile 208 associated with received payment details for identification of the blockchain wallet linked thereto.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, notification messages, response messages, cryptographic keys, blockchain transactions, blockchain data values, digital signatures, smart contracts, transaction messages, authorization responses, converted currency amounts, authentication requests, etc.

The processing server 102 can also include a validation module 220. The validation module 220 can be configured to perform validations for the processing server 102 as part of the functions discussed herein. The validation module 220 can receive instructions as input, which can also include data to be used in performing a validation, can perform a validation as requested, and can output a result of the validation to another module or engine of the processing server 102. The validation module 220 can, for example, be configured to validate digital signatures, authenticate registration data, validate compliance of a transaction message with established criteria, etc.

The processing server 102 can also include a transmitting device 222. The transmitting device 222 can be configured to transmit data over one or more networks via one or more network protocols. In some instances, the transmitting device 222 can be configured to transmit data to blockchain nodes 106, computing devices 110, issuer systems 114, merchant systems 116, payment networks 118, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes 106 that can be superimposed or otherwise encoded with requests for blockchain data, requests for smart contract data, validation requests, new blockchain transactions, smart contracts, smart contract input data, cryptographic keys, etc. The transmitting device 222 can also be configured to electronically transmit data signals to computing devices 110, which can be superimposed or otherwise encoded with confirmation messages, transaction identifiers, cryptographic keys, data requests, etc. The transmitting device 222 can also be configured to electronically transmit data signals to

### Process for Registration of a Linked Blockchain Wallet and Payment Card

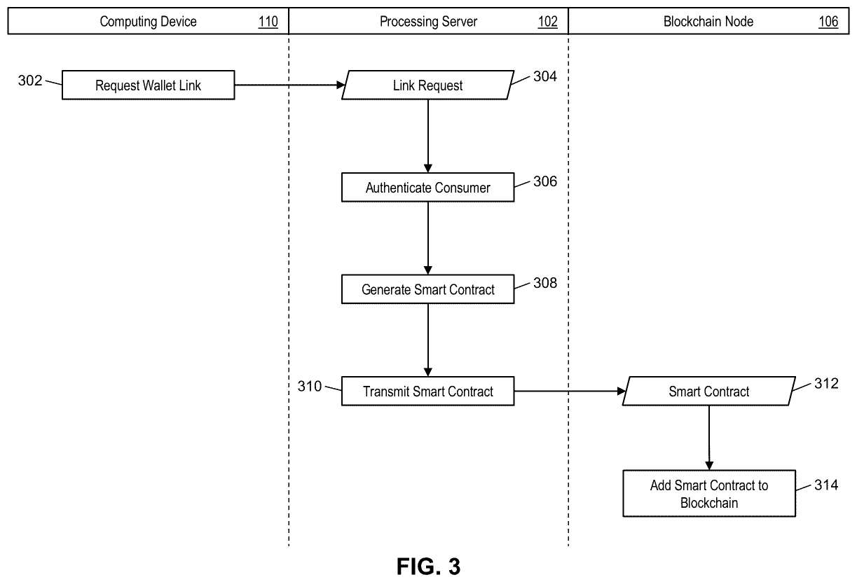

FIG. 3 illustrates a process for registering a payment card for linking with a blockchain wallet to initiate blockchain transactions therefrom in the system 100 of FIG. 1.

In step 302, the computing device 110 can submit a request message to the processing server 102 using a suitable communication network and method that requests a link between a payment card 112 and the blockchain wallet of the computing device 110. In step 304, the receiving device 202 of the processing server 102 can receive the link request message. The link request message can include at least payment details for the payment card 112 (e.g., a payment account number), an identifier for the blockchain wallet (e.g., public key), and data used for authentication of the consumer 108 as a verified user of the payment card 112 (e.g., account details, username and password, etc.). In step 306, the processing server 102 can authenticate the consumer 108 using the provided data, which can include transmitting a request to the issuer system 114 that issued the payment card 112 with the provided data and receiving a positive result indicating that the consumer 108 is authorized to use the payment card 112.

Once the consumer 108 is authenticated, then, in step 308, the processing server 102 can store the linkage data in an account profile 208 for the consumer 108 and the generation module 218 thereof can generate a new smart contract. The smart contract can include the data identifying the blockchain wallet of the computing device 110 and an indication that the processing server 102 is approved to initiate blockchain transactions on behalf of that blockchain wallet, which can also include a public key or other data of a blockchain wallet or other cryptographic key pair of the processing server 102. In step 310, the transmitting device 222 of the processing server 102 can electronically transmit the smart contract to a blockchain node 106 using a suitable communication network and method.

In step 312, the blockchain node 106 can receive the smart contract. The blockchain node 106 can confirm and verify the smart contract using traditional methods, which can include transmission of the smart contract to a plurality of additional blockchain nodes 106 in the blockchain network 104 and receipt of approval therefrom. In step 314, the smart contract can be added to the blockchain via inclusion in a new blockchain data value that is included in a new block that is confirmed and added to the blockchain. In some embodiments, a transaction identifier can be identified for the new blockchain data value and returned to the processing server 102 following submission of the smart contract. In such embodiments, the processing server 102 can forward the transaction identifier to the computing device 110, which can use the transaction identifier to verify that the smart contract is correct. The consumer 108 can then be free to use the payment card 112 for payment transactions to be funded via blockchain currency with their blockchain wallet.

### Process for Processing a Blockchain Transaction with a Linked Payment Card

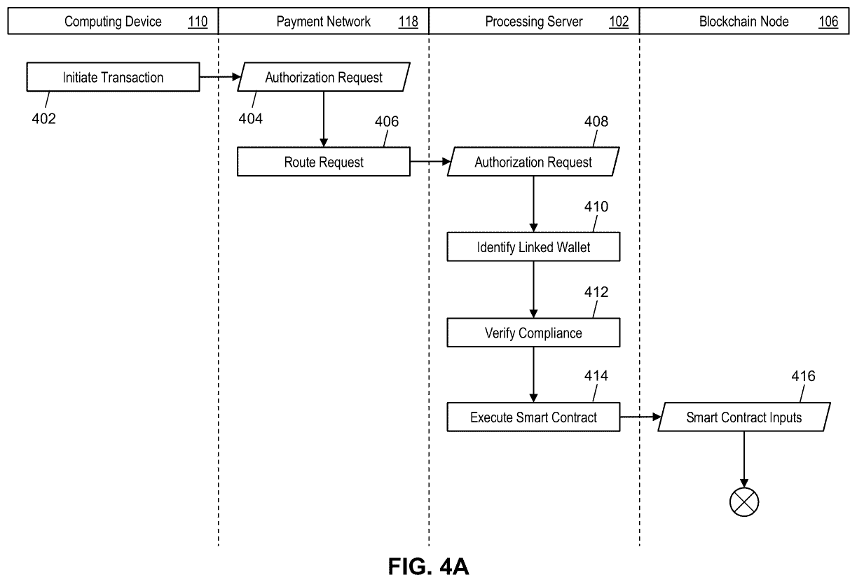

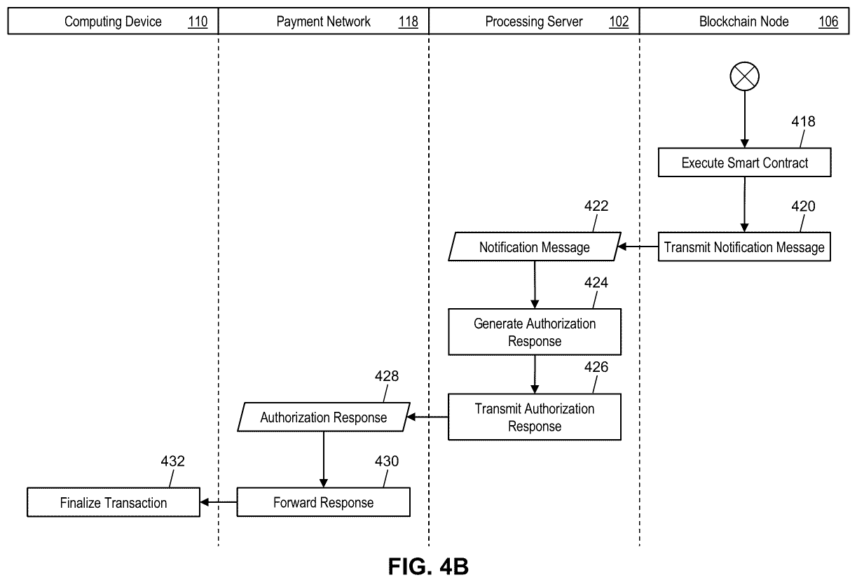

FIGS. 4A and 4B illustrate a process for the processing of a blockchain transaction using a linked payment card in the system 100 of FIG. 1.

In step 402, the computing device 110 (e.g., or consumer 108 associated therewith) can initiate a payment transaction with a merchant system 116. As part of the payment transaction, payment details of the payment card 112 can be provided to the merchant system 116, where payment is requested to be made via a blockchain currency associated with the blockchain wallet of the computing device 110. After the transaction has been initiated, the payment network 118 can receive an authorization request message from the merchant system 116 via payment rails of the payment network 118. The authorization request can be a specially formatted transaction message that includes transaction data, which can include at least a transaction amount, a currency identifier associated with the blockchain currency, and a destination address for receipt of the blockchain currency for the merchant system 116. In step 406, the payment network 118 can route the transaction message via the payment rails to the processing server 102, either directly or via the issuer system 114.

In step 408, the receiving device 202 of the processing server 102 can receive the authorization request for the payment transaction. In step 410, the querying module 216 of the processing server 102 can execute a query on the account database 206 of the processing server 102 to identify an account profile 208 that includes the payment account number included in the payment details stored in the authorization request to identify the blockchain wallet associated therewith. In step 412, the validation module 220 of the processing server 102 can verify that the payment transaction is in compliance with any criteria set forth by the consumer 108 during registration, such as ensuring that the transaction amount is within a specific account limit.

Once the payment transaction has been verified as in compliance with the applicable criteria, then, in step 414, the processing server 102 can initiate execution of the smart contract established during registration by the consumer 108. Initiation of the execution of the smart contract can include transmission, by the transmitting device 222 of the processing server 102, input data for the smart contract to the blockchain node 106 using a suitable communication network and method. The input data can include at least the transaction amount and destination address from the authorization request, as well as any data necessary for initiation of a blockchain transaction by the smart contract, such as a digital signature over the input data by a private key of the processing server 102.

In step 416, the blockchain node 106 can receive the smart contract input data from the processing server 102. In step 418, the blockchain node 106 can provide the input data as input to the smart contract and execute the smart contract on the blockchain. The smart contract can validate the authorization of the processing server 102 to initiate the blockchain transaction on behalf of the computing device 110 and then generate a new blockchain transaction for transfer of the input amount of blockchain currency from the blockchain wallet to the input destination address, which is added to the blockchain. The smart contract can provide a transaction identifier for the new blockchain transaction that is output to the blockchain node 106 as part of the execution. In cases where a swap is performed, the smart contract can perform the necessary actions to ensure that the swap is performed to exchange the blockchain currency used by the computing device 110 to the blockchain currency preferred by the merchant system 116. In step 420, the blockchain node 106 can transmit a notification message to the processing server 102 that includes the transaction identifier for the new blockchain transaction.

In step 422, the receiving device 202 of the processing server 102 can receive the notification message from the blockchain node 106. In step 424, the generation module 218 of the processing server 102 can generate an authorization response for the payment transaction, which can be a specially formatted transaction message that includes a message type indicator indicative of an authorization response and a plurality of data elements configured to store data including a response code indicating approval of the payment transaction. In some embodiments, the transaction identifier can be stored in one of the data elements in the authorization response, such as a data element reserved for private use. In step 426, the transmitting device 222 of the processing server 102 can electronically transmit the authorization response to the payment network 118 using payment rails associated therewith.

In step 428, the payment network 118 can receive the authorization response from the processing server 102. In step 430, the payment network 118 can forward the authorization response to the merchant system 116 using the payment rails. The merchant system 116 can then finalize the payment transaction. As part of the finalizing of the payment transaction, in step 432 the computing device 110 can receive confirmation of the processed payment transaction for the purchase of goods or services. In cases where a transaction identifier was included in the authorization response, the merchant system 116 can provide the transaction identifier to the computing device 110, such as on a receipt or in a confirmation email. In other cases, the processing server 102 can transmit a separate notification message to the computing device 110 indicating successful processing of the blockchain transaction and the transaction identifier thereof.

### Exemplary Method for Processing Blockchain Transactions

FIG. 5 illustrates a method 500 for the processing of a blockchain transaction using a payment card and a linked blockchain wallet.

In step 502, an authorization request for a payment transaction initiated using a payment card (e.g., payment card 112) can be received by a receiver (e.g., receiving device 202) of a processing server (e.g., processing server 102), wherein the authorization request includes transaction data, the transaction data including at least a payment card number, a transaction amount, and a destination address. In step 404, a linked blockchain wallet can be identified by a processor (e.g., querying module 216) of the processing server based on an association between the linked blockchain wallet and the payment card number.

In step 406, compliance with one or more restrictions on use of the linked blockchain wallet can be verified by the processor (e.g., validation module 220) of the processing server based on at least the transaction data and a transaction history of the linked blockchain wallet. In step 408, a smart contract stored on a blockchain of a blockchain network (e.g., blockchain network 104) associated with the linked blockchain wallet can be executed by a transmitter (e.g., transmitting device 222) of the processing server, where at least the transaction amount and destination address are provided as input for the smart contract.

In one embodiment, identifying the linked blockchain wallet can include identifying, in an account database (e.g., account database 206) of the processing server, an account profile (e.g., account profile 208) including an identifier of the linked blockchain wallet and the payment card number. In a further embodiment, the account profile can further include a permission value indicating permission to process the payment transaction using blockchain currency, and verifying compliance with one or more restrictions on use can include verifying the permission value included in the account profile. In another further embodiment, the account profile can further include an available balance for the linked blockchain wallet, and verifying compliance with one or more restrictions on use can include verifying that the transaction amount is less than the available balance. In an even further embodiment, the available balance can be one of: an integer value amount or a percentage.

In some embodiments, the transaction data included in the authorization request can further include a currency identifier associated with the blockchain network. In one embodiment, the authorization request can be a transaction message formatted according to one or more standards governing the exchange of messages in payment transactions. In a further embodiment, the one or more standards can include ISO 8583.

### Computer System Architecture

FIG. 6 illustrates a computer system 600 in which embodiments of the present disclosure, or portions thereof, can be implemented as computer-readable code. For example, the computing device 102, blockchain nodes 106, merchant system 108, and provider system 110 can be implemented in the computer system 600 using hardware, non-transitory computer readable media having instructions stored thereon, or a combination thereof and can be implemented in one or more computer systems or other processing systems. Hardware can embody modules and components used to implement the methods of FIGS. 3, 4A, 4B, and 5.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 604 can be a special purpose or a general purpose processor device specifically configured to perform the functions discussed herein. The processor device 604 can be connected to a communications infrastructure 606, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 can also include a main memory 608 (e.g., random access memory, read-only memory, etc.), and can also include a secondary memory 610. The secondary memory 610 can include the hard disk drive 612 and a removable storage drive 614, such as a floppy disk drive, a magnetic tape drive, an optical disk drive, a flash memory, etc.

The removable storage drive 614 can read from and/or write to the removable storage unit 618 in a well-known manner. The removable storage unit 618 can include a removable storage media that can be read by and written to by the removable storage drive 614. For example, if the removable storage drive 614 is a floppy disk drive or universal serial bus port, the removable storage unit 618 can be a floppy disk or portable flash drive, respectively. In one embodiment, the removable storage unit 618 can be non-transitory computer readable recording media.

In some embodiments, the secondary memory 610 can include alternative means for allowing computer programs or other instructions to be loaded into the computer system 600, for example, the removable storage unit 622 and an interface 620. Examples of such means can include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 600 can also include a communications interface 624. The communications interface 624 can be configured to allow software and data to be transferred between the computer system 600 and external devices. Exemplary communications interfaces 624 can include a modem, a network interface (e.g., an Ethernet card), a communications port, a PCMCIA slot and card, etc. Software and data transferred via the communications interface 624 can be in the form of signals, which can be electronic, electromagnetic, optical, or other signals as will be apparent to persons having skill in the relevant art. The signals can travel via a communications path 626, which can be configured to carry the signals and can be implemented using wire, cable, fiber optics, a phone line, a cellular phone link, a radio frequency link, etc.

The computer system 600 can further include a display interface 602. The display interface 602 can be configured to allow data to be transferred between the computer system 600 and external display 630. Exemplary display interfaces 602 can include high-definition multimedia interface (HDMI), digital visual interface (DVI), video graphics array (VGA), etc. The display 630 can be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 608 and secondary memory 610, which can be memory semiconductors (e.g., DRAMs, etc.). These computer program products can be means for providing software to the computer system 600. Computer programs (e.g., computer control logic) can be stored in the main memory 608 and/or the secondary memory 610. Computer programs can also be received via the communications interface 624. Such computer programs, when executed, can enable computer system 600 to implement the present methods as discussed herein. In particular, the computer programs, when executed, can enable processor device 604 to implement the methods illustrated by FIGS. 3, 4A, 4B, and 5, as discussed herein. Accordingly, such computer programs can represent controllers of the computer system 600. Where the present disclosure is implemented using software, the software can be stored in a computer program product and loaded into the computer system 600 using the removable storage drive 614, interface 620, and hard disk drive 612, or communications interface 624.

The processor device 604 can comprise one or more modules or engines configured to perform the functions of the computer system 600. Each of the modules or engines can be implemented using hardware and, in some instances, can also utilize software, such as corresponding to program code and/or programs stored in the main memory 608 or secondary memory 610. In such instances, program code can be compiled by the processor device 604 (e.g., by a compiling module or engine) prior to execution by the hardware of the computer system 600. For example, the program code can be source code written in a programming language that is translated into a lower level language, such as assembly language or machine code, for execution by the processor device 604 and/or any additional hardware components of the computer system 600. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for processing a blockchain transaction using a payment card and a linked blockchain wallet. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for processing a blockchain transaction using a payment card and a linked blockchain wallet, comprising:
receiving, by a receiver of a processing server, an authorization request for a payment transaction initiated using the payment card, wherein the authorization request includes transaction data, the transaction data including at least a payment card number, a transaction amount, and a destination address;
identifying, by a processor of the processing server, the linked blockchain wallet based on an association between the linked blockchain wallet and the payment card number;
verifying, by the processor of the processing server, compliance with one or more restrictions on use of the linked blockchain wallet based on at least the transaction data and a transaction history of the linked blockchain wallet; and
executing, by a transmitter of the processing server, a smart contract stored on a blockchain of a blockchain network associated with the linked blockchain wallet, where at least the transaction amount and destination address are provided as input for the smart contract.

2. The method of claim 1, wherein identifying the linked blockchain wallet includes identifying, in an account database of the processing server, an account profile including an identifier of the linked blockchain wallet and the payment card number.

3. The method of claim 2, wherein
the account profile further includes a permission value indicating permission to process the payment transaction using blockchain currency, and
verifying compliance with one or more restrictions on use includes verifying the permission value included in the account profile.

4. The method of claim 2, wherein
the account profile further includes an available balance for the linked blockchain wallet, and
verifying compliance with one or more restrictions on use includes verifying that the transaction amount is less than the available balance.

5. The method of claim 4, wherein the available balance is one of: an integer value amount or a percentage.

6. The method of claim 1, wherein the transaction data included in the authorization request further includes a currency identifier associated with the blockchain network.

7. The method of claim 1, wherein the authorization request is a transaction message formatted according to one or more standards governing the exchange of messages in payment transactions.

8. The method of claim 7, wherein the one or more standards includes ISO 8583.

9. The method of claim 1, wherein execution of the smart contract results in a swap being performed to exchange blockchain currency from the blockchain of the blockchain network to a second currency.

10. A system for processing a blockchain transaction using a payment card and a linked blockchain wallet, comprising:
a blockchain network; and
a processing server, the processing server including
a receiver receiving an authorization request for a payment transaction initiated using the payment card, wherein the authorization request includes transaction data, the transaction data including at least a payment card number, a transaction amount, and a destination address,
a processor
identifying the linked blockchain wallet based on an association between the linked blockchain wallet and the payment card number, and
verifying compliance with one or more restrictions on use of the linked blockchain wallet based on at least the transaction data and a transaction history of the linked blockchain wallet, and
a transmitter executing a smart contract stored on a blockchain of the blockchain network associated with the linked blockchain wallet, where at least the transaction amount and destination address are provided as input for the smart contract.

11. The method of claim 10, wherein identifying the linked blockchain wallet includes identifying, in an account database of the processing server, an account profile including an identifier of the linked blockchain wallet and the payment card number.

12. The system of claim 11, wherein
the account profile further includes a permission value indicating permission to process the payment transaction using blockchain currency, and
verifying compliance with one or more restrictions on use includes verifying the permission value included in the account profile.

13. The system of claim 11, wherein
the account profile further includes an available balance for the linked blockchain wallet, and
verifying compliance with one or more restrictions on use includes verifying that the transaction amount is less than the available balance.

14. The system of claim 13, wherein the available balance is one of: an integer value amount or a percentage.

15. The system of claim 10, wherein the transaction data included in the authorization request further includes a currency identifier associated with the blockchain network.

16. The system of claim 10, wherein the authorization request is a transaction message formatted according to one or more standards governing the exchange of messages in payment transactions.

17. The system of claim 16, wherein the one or more standards includes ISO 8583.

18. The system of claim 10, wherein execution of the smart contract results in a swap being performed to exchange blockchain currency from the blockchain of the blockchain network to a second currency.
